(19) United States
(12) Patent Application Publication
(10) Pub. No.: US 2013/0089654 A1
(43) Pub. Date: Apr. 11, 2013

(54) Ready To Use Garlic Paste

(71) Applicant: Ziv Yehuda Simhi, Springfield, OR (US)

(72) Inventor: Ziv Yehuda Simhi, Springfield, OR (US)

(21) Appl. No.: 13/269,646

(22) Filed: Oct. 10, 2011

(51) Int. Cl. A23L 1/221; A23L 3/36

(52) U.S. Cl. 426/638

(57) ABSTRACT

A method of making a garlic paste comprising the steps of grinding at least one cleaned and dried clove of garlic to provide a pulp of garlic and garlic juice; mixing the garlic juice with the pulp to form a paste; adding to the garlic paste between ten and thirty grams of salt for each one hundred grams of garlic paste; adding between one gram and fifteen grams of editable oil to each one hundred grams of garlic paste until a desired consistency is obtained; and placing the mixture of garlic paste, salt and editable oil into a closable container and inserting the closed container into a freezer.

### BACKGROUND OF THE INVENTION

1. Field of the Invention

The present invention relates generally to garlic and more specifically to a method of forming a garlic paste by grinding at least one clove of garlic to form a pulp of garlic and garlic juice, mixing the pulp with the garlic juice to form a paste and adding salt and an editable oil to the garlic paste. The paste of pulp, garlic juice, salt and editable oil, when placed in a freezer, will retain its flavor, aroma and freshness for a period of time which is longer than the shelf life of fresh garlic and can be used immediately upon removal from the freezer without having to be thawed. In an embodiment of the invention a ground vegetable can be added to the mixture which is then stored in a freezer for subsequent use.

2. Description of Related Art

The processing of garlic is known in the prior art. More specifically, by way of example, U.S. PreGrant Publication No. 2007/0160741 to Moreno; et al. discloses a method of making a ready to use frozen garlic product. Clean garlic cloves are minced into minced garlic and garlic juice, which is combined into garlic pulp. The garlic pulp is mixed with edible salt at a ratio of 13-25 grams of salt to every 100 grams of garlic pulp. The homogeneous mixture is stored in containers which are placed in freezing conditions, in temperatures ranging from −4.degrees C. to some minimal freezing temperature, the minimal freezing temperature depending on the concentration of salt in the mixture of garlic pulp and salt.

U.S. PreGrant Publication No. 2006/0019002 to Xue discloses a method for processing and packaging garlic where a small fragment of the stem of a peeled clove is cut off and the clove is then washed. The clove is then surface sterilized and packaged in a plastic bag which is sealed under vacuum.

U.S. PreGrant Publication No. 2005/0287261 to Zhou; et al. discloses a method for preserving the freshness of garlic cloves using vacuum packs to extend the retail shelf life from one month to three months. The cloves are separated within small bags which eliminates garlic smell and cross-contamination from other cloves.

U.S. PreGrant Publication No. 2005/0123669 to Yamada discloses eliminating the differences in the color, taste and smell of the cloves of different bulbs by using a natural material extracted from natural garlic which contains water-soluble organic sulfur compound S-allylcysteine that is added to a previously heated garlic-yolk mixture.

U.S. PreGrant Publication No. 2004/0258815 to Zaboli discloses a method of processing fresh garlic to remove the characteristic odor it produces after ingestion by saturating the garlic in a water-based fluid and then thawing the garlic.

U.S. Pat. No. 6,096,366 to Onove discloses a process of making a marinated frozen garlic product in which the garlic is marinated in vinegar, minced, combined with olive oil, and frozen.

U.S. Pat. No. 5,260,090 to Isao discloses removing more than 50% of the odor-producing allyl sulfides present in garlic by immersion the garlic in a solution of bicarbonate of soda. The solution is buffered with one or more organic acids such as citric acid to restrict the action of the bicarbonate of soda and to neutralize alkaline components to reduce the bitter taste and eliminate the bad oral odor or body odor which is generated after eating.

### SUMMARY OF THE INVENTION

In an exemplary embodiment of the present invention, there is disclosed a method of making a garlic paste comprising the steps of:

grinding at least one cleaned and dried clove of garlic to provide a pulp of garlic and garlic juice;

mixing the garlic juice with the pulp to form a paste;

adding to the garlic paste between ten and thirty grams of salt for each one hundred grams of garlic paste;

adding between one gram and fifteen grams of editable oil to each one hundred grams of garlic paste until a desired consistency is obtained; and placing the mixture of garlic paste, salt and editable oil into a closable container and inserting the closed container into a freezer.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flow diagram of a method of processing and storing fresh garlic for use at a future date which may be beyond the shelf life of fresh garlic while keeping the freshness, smell and flavor of fresh garlic without using preservatives or artificial ingredients in accordance with the principles of the invention.

### DESCRIPTION OF THE PREFERRED EMBODIMENT

In its frozen state, while in a freezer at zero degrees Fahrenheit, garlic paste will not freeze and will stay soft. Thus, as garlic paste stays soft at zero degrees F., it does not have to be thawed and can be used immediately upon removal from a freezer. When garlic is frozen its freshness is preserved and its flavor and aroma is not lost. In addition, the freshness of garlic paste is extended for a long time beyond the shelf life of fresh garlic.

If desired, the garlic paste can be mixed with natural ingredients such as ground vegetables that can be kept in a freezer and still stay soft, pliable and ready for immediate use upon removed from the freezer without thawing. Some examples of ground vegetables that can be mixed with the paste are basil, ginger, carrots, turnips, beets, chickpeas, etc.

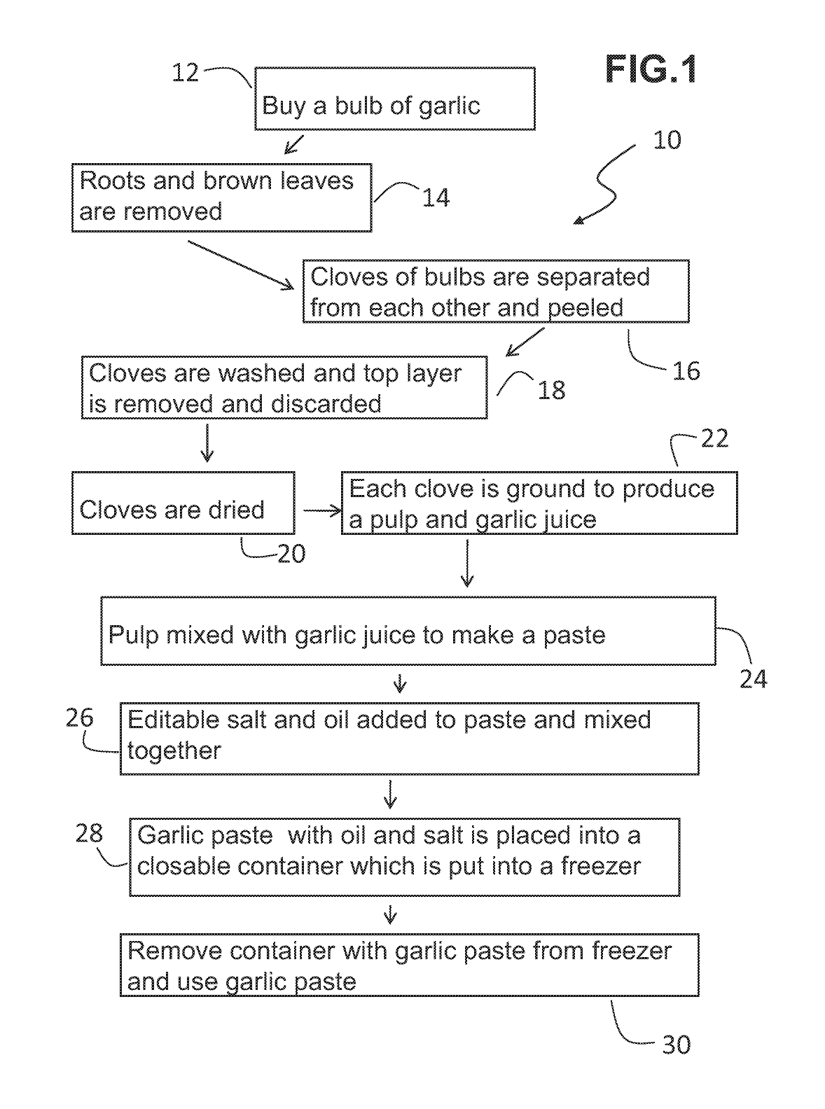

Referring to FIG. 1, there is disclosed a flow diagram 10 of a method of grinding a clove of garlic into a pulp, combining the pulp with the garlic juice formed during the grinding process to form a paste and storing garlic paste in a freezer for use at a future date which may be beyond the shelf life of fresh garlic where the garlic paste will keep the freshness, smell and flavor of fresh garlic without having used preservatives or artificial ingredients.

Initially a garlic bulb is purchased from a store, block 12, the brown leaves and any roots that are on the bulb are removed, block 14, and the cloves of the bulb are separated from each other, block 16. Each clove is now washed in warm water, the top layer of each clove is removed, block 18, and the cloves are placed on a cloth or paper towel to dry, block 20.

Each dry clove is now ground to produce a pulp of garlic and garlic juice, block 22. The pulp of garlic and the garlic juice which results from the grinding process are now combined to produce a garlic paste, block 24. The cloves can be ground in a meat grinder, crushed or a food processor.

Salt and Editable oil such as olive oil, canola oil, corn oil, etc. are added to the garlic paste to form a mixture. Salt in an amount that is between ten and thirty grams for each one hundred grams of garlic paste is added to the garlic paste, and an amount of oil which provides the garlic paste with a desired consistency is added to the paste, block 26. The mixture of garlic paste, salt and oil is now placed into a freezer which is at or near zero degrees F., block 28. At some time thereafter the garlic paste is removed from the freezer and is immediately ready for use without thawing, block 30.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method of making a garlic paste comprising the steps of:
grinding at least one cleaned and dried clove of garlic to provide a pulp of garlic and garlic juice;
mixing the garlic juice with the pulp to form a paste;
adding to the garlic paste between ten and thirty grams of salt for each one hundred grams of garlic paste;
adding between one gram and fifteen grams of editable oil to each one hundred grams of garlic paste until a desired consistency is obtained; and
placing the mixture of garlic paste, salt and editable oil into a closable container and inserting the closed container into a freezer.

2. The method of claim 1 wherein the cold mixture of garlic paste salt and editable oil is spreadable without thawing immediately after being removed from the freezer.

3. The method of claim 1 wherein the at least one clove of garlic is ground in a meat grinder.

4. The method of claim 1 wherein the at least one clove of garlic is crushed.

5. The method of claim 1 wherein the at least one clove of garlic is ground in a food processor.

6. The method of claim 1 wherein the editable oil is olive oil.

7. The method of claim 1 wherein the editable oil is canola oil.

8. The method of claim 1 wherein the editable oil is corn oil.

9. The method of claim 1 wherein the mixture of garlic paste, salt and editable oil is mixed with a ground vegetable before being placed in a closed container.

10. The method of claim 7 wherein the ground vegetable is basil.

11. The method of claim 7 wherein the ground vegetable is ginger.

12. The method of claim 7 wherein the ground vegetable is carrots.
